(19) United States
(12) Patent Application Publication
(10) Pub. No.: US 2010/0180323 A1
(43) Pub. Date: Jul. 15, 2010

(54) STATEFUL SERVER BASED SOCIAL NETWORKING USING MOBILE DEVICES

(75) Inventors: Jean-Marc Matteini, La Selva Beach, CA (US); Arjan van Ham, San Jose, CA (US)

Correspondence Address: PERKINS COIE LLP, P.O. BOX 1208, SEATTLE, WA, 98111-1208, US

(73) Assignee: mxmd, inc., San Jose, CA (US)

(21) Appl. No.: 12/351,703

(22) Filed: Jan. 9, 2009

(51) Int. Cl. G06F 15/16; G06F 21/00

(52) U.S. Cl. 726/5; 709/206

(57) ABSTRACT

The present invention provides methods and systems for using a stateful server for social networking using mobile devices. In one embodiment, a user uses a mobile device to register for a networking service offered by the stateful server. The stateful server transmits several tiers of service options to the user, and generates responses based on the user's selection to the service options. The stateful server establishes a unique state for each session initiated by the user, and stores all information related to the session in association with the unique state. The stateful server removes hyperlinks from text messages transmitted to the user's mobile device. The stateful server stores correlation information of the removed hyperlinks in association with the unique state. The stateful server enables the user to establish a friend network and to transmit information associated with the unique state to contacts within the friend network.

### FIELD OF INVENTION

The present invention generally relates to the field of social networking using mobile devices. More particularly, the present invention relates to methods and systems for using a stateful server to enable social networking through mobile devices.

### BACKGROUND OF THE INVENTION

Mobile devices (also called wireless phones, cell phones, cellular telephones, etc.) have become a ubiquitous source of telecommunication. Beyond the quintessential use of mobile devices as telecommunication devices, a large number of users rely on the mobile devices for a variety of other functions. Examples of such functions include calendar scheduling, maintaining contact information, communication through text based (e.g., SMS) messages, etc.

Despite the growth in popularity of web-based services (e.g., using Wireless Application Protocols or WAP) in mobile telephones, text messaging remains hugely popular because of several reasons. First, text messages can be used to communicate with a person regardless of whether the person carries a WAP enabled phone or not. Second, a large number of mobile users prefer not to switch to the WAP enabled mobile phones owing to the higher cost of WAP service provided by the carrier network of the mobile device. Therefore, a large demand exists for mobile users to be able to continue communicating using text based messages.

Additionally, in a social context, online social networking sites (e.g., Twitter®, Facebook®, LinkedIn®, etc.) are becoming increasingly popular to establish and maintain contact with a large number of professional and personal contacts. However, these products are geared towards communication with a larger corpus of contacts, and do not address the communication needs of a close-knit group of contacts (e.g., close friends, family, etc.). This close-knit group of contacts, for example, is a relatively small number of people with whom a user may actually hang out in the real world (as opposed to the cyber-world). Social interactions with such a close-knit group of contacts also tend to be more casual and spur-of-the-moment type of activities.

Moreover, even when a person maintains a close group of contacts in such online networking sites, there are situations when the person is unable to access the internet to be able to communicate with such contacts. For example, consider the scenario when the person is traveling in a bus coming back from work, and decides he wants to watch a movie with his close friends that evening. Assuming he does not have a WAP enabled mobile device, he is forced to wait until he gains access to a computer before he can determine what movies are available at a particular location and to purchase tickets for that movie. Even in the case where the person has a WAP enabled phone, he has to squint or exert additional stress to view web-based information using the display of a mobile device.

The other option would be to call a directory service to get the information. However, there are at least two problems associated with such an approach. First, the directory service calls are expensive and may become prohibitive if the user wants to get information about several movies. Second, even if he used this approach, he would still be unable to forward the information about a particular movie or a choice of several movies to his close group of friends unless he calls or sends a text message to each of his close group of friends.

Therefore, a need exists to deliver a more focused social networking effort targeted toward this close-knit group of people utilizing a mobile text messaging environment.

### SUMMARY OF THE DESCRIPTION

At least one embodiment of this invention pertains to the use of a stateful server that enables a mobile device user to engage in social networking activities without the use of the Internet (or in some instances, without using a network browser of a mobile device). In some instances, a user registers for a friend network service offered by a stateful server by utilizing a registration code. The stateful server provides the user with a list of service options related to events in a particular geographic location. The stateful server provides this list in the form of a text message sent to the user's mobile device.

In one embodiment, when the user selects a particular service option, the stateful server aggregates information related to that particular service option. The stateful server establishes a unique state for the series of exchanges between the user and the stateful server. The stateful server stores the aggregated information in association with the unique state in a database. In some instances, the stateful server obfuscates or removes hyperlinks from messages transmitted to the user's mobile device. The stateful server maintains a correlation of the removed (or obfuscated) hyperlinks from the transmitted message to their actual location in the aggregated information. In some instances, the stateful server stores the correlation information in association with the unique state.

By removing the hyperlinks, the message transmitted to the user's mobile device is in the form of character strings. Therefore, the user can view the complete information from the message regardless of whether his phone has WAP capability or not. Additionally, when the user opts to receive additional information related to the received message, the stateful server maps the request to the aggregated information stored in association with the unique state to generate a suitable response to the user's mobile device.

In some embodiments, the stateful server enables the user to establish a friend network. The stateful server provides the user with registration codes to enable the user to invite social contacts to join his friend network. The stateful server registers the social contacts after they transmit their respective registration codes to the stateful server utilizing text messages from their mobile devices.

After the user receives information from the stateful server about a social event, the user can choose to transmit information about the social event to his social contacts. In some instances, the stateful server enables the user to transmit the information associated with the unique state to all social contacts within his friend network. In other instances, the stateful server enables the user to pick one or more friends from a list of social contacts, after which the stateful server transmits information stored in association with the unique state to the selected social contacts.

In some instances, the stateful server permits the social contacts to access information stored in association with the unique state by transmitting a list of service options to the social contacts. The social contacts, in some instances, are then allowed to transmit messages to the other social contacts or to the user, and in some cases, to even modify the data stored in association with the unique state.

Other advantages and features will become apparent from the following description and claims. It should be understood that the description and specific examples are intended for purposes of illustration only and not intended to limit the scope of the present disclosure.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings.

FIG. 1 is a top-level block diagram illustrating the stateful server in communication with a mobile device;

FIG. 2 is a schematic diagram illustrating the interaction between the stateful server and the mobile device;

FIG. 3 is a flow diagram depicting a method by which a mobile user can register for the friend network service;

FIG. 4 is a flow diagram illustrating a method by which a primary mobile user adds an additional social contact to the primary user's friend network;

FIG. 5 is a flow diagram illustrating a method by which a user utilizes the friend network service to receive information related to social events;

FIGS. 6A-6E depict various examples of the first list of options displayed in the user's mobile device;

FIG. 7 is a flow diagram illustrating a method allowing a user to invite a contact from the user's friend network to a social event; and

FIG. 8 is a high-level block diagram showing an example of the architecture for a computer system.

### DETAILED DESCRIPTION OF THE INVENTION

The present invention may be embodied in several forms and manners. The description provided below and the drawings show exemplary embodiments of the invention. Those of skill in the art will appreciate that the invention may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

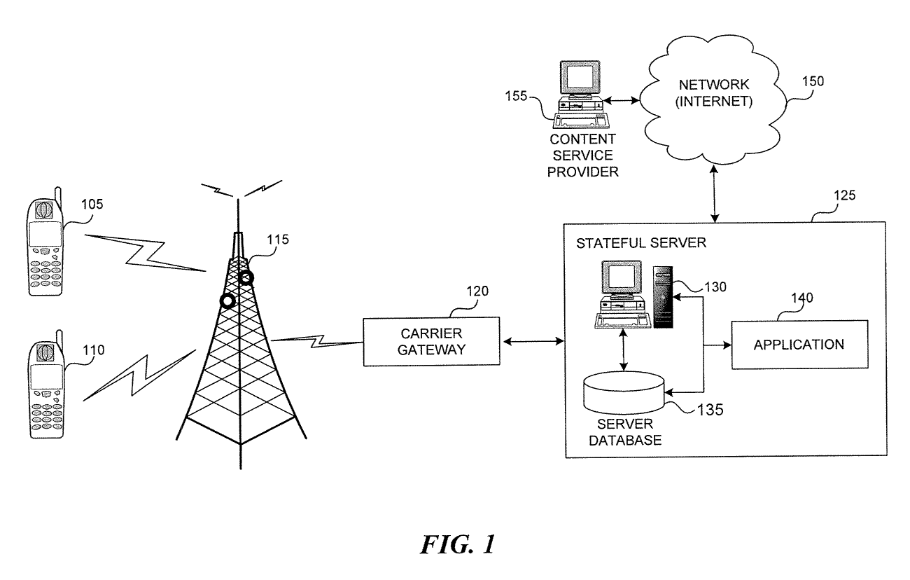

FIG. 1 is a top-level block diagram illustrating the stateful server in communication with a mobile device. In one embodiment, a mobile device (e.g., 105, 110) is utilized for the purpose of implementing the techniques described herein. Examples of a mobile device include a mobile cellular telephone device. The mobile device utilizes an associated carrier network for voice and data communication requirements. In some instances, the mobile device establishes contact with the carrier network by means of a mobile communication tower (“mobile tower”) 115 installed at various locations by, for example, the operator of the mobile carrier network.

The mobile tower 115 communicates through the carrier network with a carrier gateway 120. In some instances, the carrier gateway 120 may be an SMS gateway (e.g., a GSM PC card) that provides an interface between the carrier network and the stateful server 125. In some instances, such an interface may be established between the carrier network and, for example, a local area network associated with the stateful server 125. Other means of communication or interfacing between the carrier network and the stateful server, as known to one of ordinary skill in the art, are equally applicable here. In some instances, the carrier gateway 120 is operated in conjunction with the storage server 125 by the operator of the storage server 125.

In some embodiments, the system includes a stateful server 125. The stateful server, in some instances, is a web server that communicates with the carrier network utilizing the carrier gateway 120. The stateful server 125 comprises a computing server 130 that communicates with at least a server database 135 to implement some of the functions of the techniques described herein. The server database 135, in some embodiments, is a tape, optical, or semiconductor storage medium that, for example, stores information related to a user of the mobile device. In some embodiments, the server database 135 also includes information related to a friend network associated with the mobile device user. Additional details on such a friend network are further discussed below.

The stateful server further includes an application 140. The application 140, in some instances, is a backend program that processes information requested by the user of the mobile device. In one embodiment, the application 140 retrieves information from a network 150 (e.g., the internet) in response to a mobile user's request and processes that information to remove or obfuscate any hyperlinks in the retrieved information. The application 140, in some instances, further associates various requests from a particular user or from contacts of a particular friend network, and causes such information to be tagged together and stored in the server database 135.

In one embodiment, the application 140 communicates through the network 150 to retrieve information from one or more content service providers 155. The content service providers 155 host data such as, for example, movie ratings, theater locations, show times, TV show schedules, etc. In some instances, the information is accessed by the stateful server 125 using APIs published by the content service providers 155 over standard internet protocols (e.g., HTTP, TCP/IP, etc.)

In one embodiment, the application 140 establishes a unique state, for example, every time a user initiates a new session to access information. The application 140 stores relevant information during a session (e.g., requests sent as text messages from the user utilizing various tiers of service option lists, information generated by the application in response to requests from the user, etc.) in association with the unique state. In some instances, the application 140 also establishes a mapping between the original information generated by the application 140 and the “clean” version of the message transmitted to the user (e.g., by removing or obfuscating hyperlinks from the original information). The application 140 stores this mapping again in association with the unique state created for the session.

Utilizing such states to store information of a session within the stateful server is advantageous for several reasons. The user (or specifically, the mobile device used by the user) does not have to keep track of information previously transmitted to the stateful server. For example, the stateful server provides the user with a first tier of service options and the user makes a selection from that first tier.

In some instances, the stateful server transmits a second tier of service options to the user's mobile device based on the selection made by the user to the first tier. In such instances, the user does not have to keep track of the prior response to the first tier and can respond purely based on the second tier of options. The stateful server saves this information in association with the state and manages tracking all requests and responses from one tier of options to the next.

Consequently, the mobile device does not have to allocate additional resources (e.g., additional memory, additional processing cycles, etc.) to accommodate the exchanges between the mobile device and the stateful server. Other advantages of utilizing a stateful server in communication with several clients, as understood by a person of ordinary skill in the art, are equally applicable here.

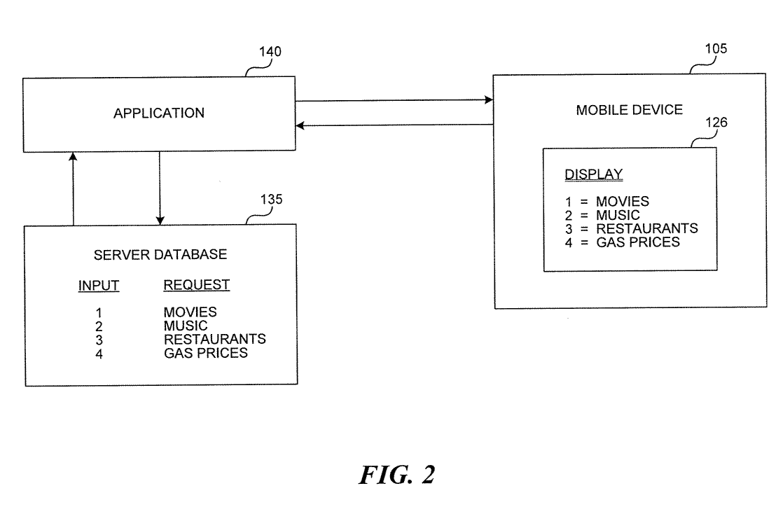

FIG. 2 is a schematic diagram illustrating the interaction between the stateful server and the mobile device 105. As indicated above, the stateful server comprises at least an application 140 and a server database 135. The server database 135 stores information that is transmitted to a mobile device user, after the user successfully registers as a user with the stateful server. In one example, as indicated in FIG. 2, the server database comprises a top level list of service options that is transmitted to a user after the user successfully registers with the stateful server. In the example shown in FIG. 2, the server database 135 includes a list of service options that include an option to inquire about movies within a geographic location, an option to inquire about music (e.g., concerts, plays, etc.) within a geographic location, an option to inquire about local restaurants, an option to inquire about gas prices within a given geographic location, etc.

In one embodiment, the storage server 140 stores all the information pertinent to the list of options (e.g., detailed information concerning movies running within a given area, ratings of such movies, purchasing tickets for such movies, etc.). The application, in some instances, assimilates this information (e.g., from a content service provider 155 as explained in FIG. 1) and generates a response that obfuscates all the hyperlink details within the information before transmitting (e.g., as a text message) the information to the display 106 of a mobile device 105. The application, as indicated above, establishes a unique state for the session and stores the information related to the session in association with the unique state.

In some instances, only the application 140 is aware of the correlation between the information transmitted to the mobile device 105 and hyperlinks associated with such information. The application stores this correlation information in association with the unique state established for the particular session. All that is transmitted to the mobile device 105 is one or more strings (e.g., the information displayed within the display 106 of the mobile device 105) that means something only to the application 140.

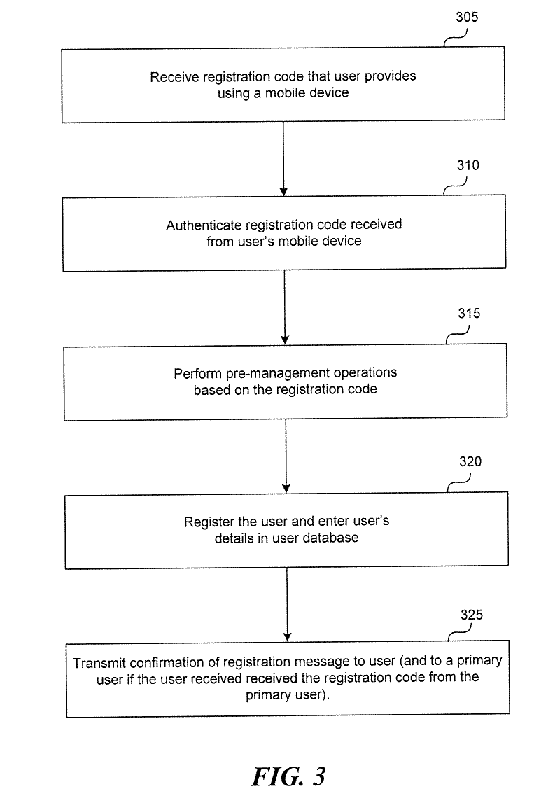

FIG. 3 is a flow diagram depicting a method by which a mobile user can register for services offered by the stateful server (hereinafter “friend network services”). In some embodiments, the mobile user is required to first enter a registration code to gain access to the friend network services. The user provides to the stateful server a registration code. The user may receive the registration code from another friend, or by sending a code request to a particular SMS number, download such a code from a website associated with the stateful server, etc.

In one embodiment, the user enters the registration code using the mobile device. The mobile user enters the registration code in the form of, for example, an SMS text message. The stateful server receives the registration code entered by the mobile user 305. The stateful server authenticates the registration code against a database of allowed registration codes in the server database 310. Upon authenticating the user's registration code, the stateful server performs one or more pre-management operations 315. Examples of the pre-management operations include ensuring the availability of sufficient bandwidth to accommodate an additional user, tracking the user's code for marketing purposes, etc. The stateful server subsequently registers the user (along with any user details provided by the user) 320. In some instances, the stateful server then transmits a confirmation of the registration to the user 325. In the event that a primary user provided the user the registration code, the confirmation message is transmitted to both the user and the corresponding primary user.

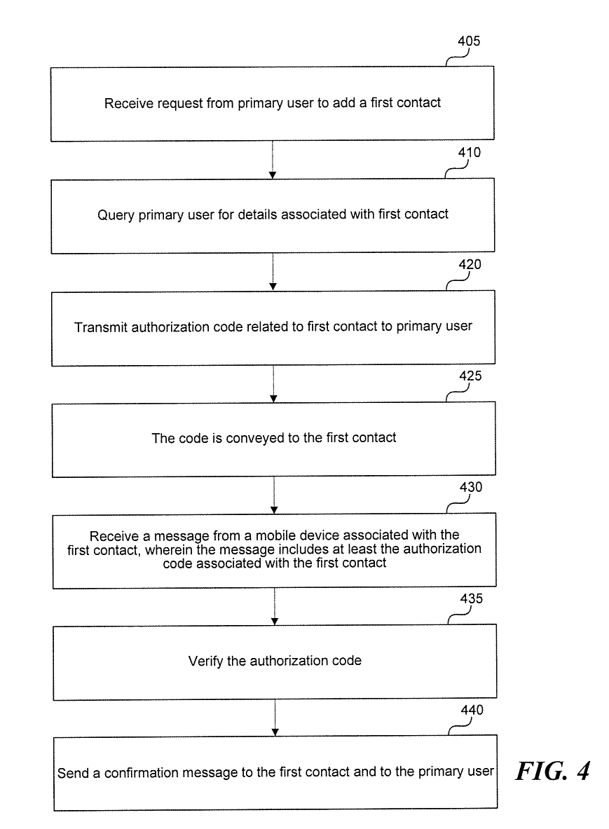

FIG. 4 is a flow diagram illustrating a method by which a primary mobile user adds an additional social contact to the primary user's friend network. In one embodiment, the primary mobile user requests the friend network service to add a friend. In one example, the mobile user sends a text message (e.g., an SMS message) to the stateful server with a specific request to add a social contact to the primary user's friend network. The additional social contact could be a friend, or a several people belonging to a family. The stateful server receives such a request through the carrier network of the mobile device (as illustrated using FIG. 1).

In some instances, in response to receiving the request from the mobile user, the friend network service on the stateful server transmits a query message to the primary user 410. The query may require the user to provide additional information about the social contact (e.g., the user's name, email address, telephone number, the social contact's user handle within the carrier network, etc.). The friend network service subsequently transmits a message to the primary user with one or more contact registration codes for the social contacts 420. The primary user, upon receiving the contact authorization code conveys the code to the specific social contacts 425.

The social contact, upon receiving the contact registration code, sends a message (with the contact registration code) to the friend network service (e.g., using an SMS text message) 430. Upon receiving the message, the friend network service authenticates the contact registration code and subsequently adds the social contact to the user's friend network 435. The friend network service then transmits a confirmation message to the social contact (and in some instances, to the primary user as well) indicating that the social contact has been added to the primary user's friend network 440.

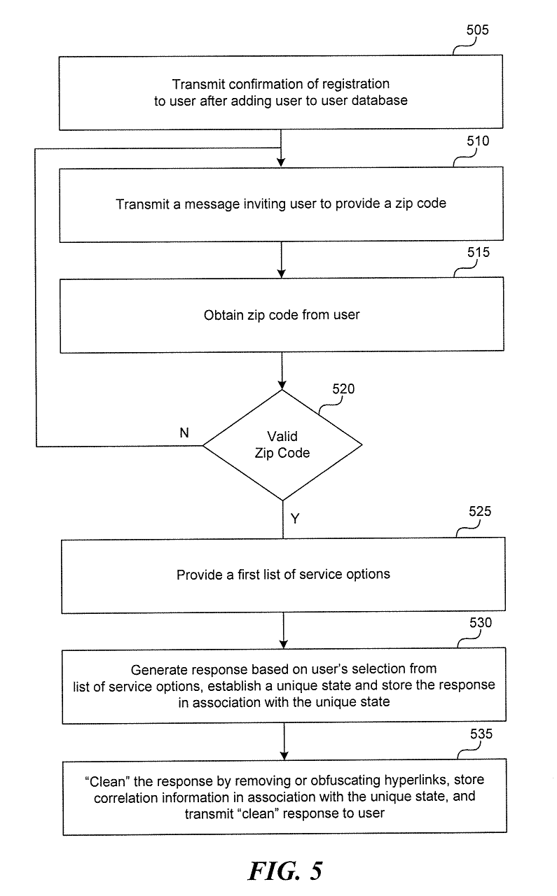

FIG. 5 is a flow diagram illustrating a method by which a user utilizes the friend network service to receive information related to social events. In one embodiment, the stateful server running the friend network service transmits a message to the user indicating that the user has been added to the friend network 505. The user, as discussed herein, could either be the primary mobile user, or one of the social contacts associated with the primary mobile user.

In some instances, the friend network service transmits a message to the user requesting the user to provide a geographic location identifier (e.g., a zip code) 510. The user provides the information as a text message back to the stateful server 515. Upon receiving the geographic location identifier, the friend network service performs a check to determine the validity of the zip code 520 (e.g., the zip code is of proper format, the zip code actually exists, the zip code refers to a location that is supported by services offered by the friend network service, etc.). If the geographic location identifier is found to be invalid, the friend network service sends another message to the user, requesting the user to supply a different identifier.

When the friend network service receives a valid geographic location identifier, it provides a list of service options relevant to the zip code 525. In some instances, the user selects one of the options by entering a numeric identifier associated with a particular option. In another instances, the user selects two or more options (or a range of options) from the list of service options. In one example, the list of service options lists movies, restaurants, music, and gas prices. When the user selects a particular option, the friend network service running on the stateful server receives information about the request. As indicated above, the stateful server establishes a unique state for the session initiated by the user, and stores the user's responses in association with the unique state.

In one illustrative example, when the user selects the “movies” option, the friend network service processes the information to generate a suitable response 530. The stateful server, in some instances, maintains information about, for example, movies related to particular geographic locations. In other instances, the stateful server queries a network (e.g., the internet) to obtain relevant information to generate the response. The information be in the form of web pages and may contain hyperlinks and other details that cannot be accessed by a mobile device user through a simple text message (e.g., when the mobile device is not WAP enabled). Furthermore, in some instances, the stateful server stores the generated information/response in association with the unique state.

The backend application associated with the stateful server removes or obfuscates the hyperlinks from the messages and develops concise and clean textual information based on the data previously available (or, in some instances, downloaded from the internet) in the database associated with the stateful server. The messages are then transmitted as a text message to the user 535. In some instances, as indicated above, the backend application stores information about correlation of the hyperlinks between the stored information and the transmitted text message, and stores such correlation information in association with the unique state.

The following scenario is another illustrative example further describing the method. When a user selects the movies option, the stateful server responds by presenting a list of local movies. When the user selects a desired movie, the friend network service provides ratings information (e.g., both the official movie rating such as G, PG, PG-13, R, etc., as well as an opinion rating based on viewer feedback, etc.). They are then asked to view further information by selecting “theater” or “showtime”.

If “theater” is selected, the service provides the user a list of local theaters. When the user selects a preferred theater, the service displays a list of movie times for their movie choice at that selected movie theater. When the user selects a time, the service provides the user with a confirmation of choice of movie, selected show time and selected movie theater and the option to purchase a movie ticket (b=buy feature). If the user chooses “showtime,” the service provides him a list of show times available at local area theaters. Once the user selects a show time, the service provides him a list of available theaters showing their choice movie at that time. When the user selects a theater, the service provides him a confirmation of choice of movie, selected show time and selected movie theater and the option to purchase a movie ticket (b=buy feature).

In some embodiments, the server database associated with the stateful server maintains a log of all requests made from users (e.g., the primary user, the social contacts, etc.) within a particular friend network. In some instances, the database utilizes a friend network identifier (e.g., a group name, a group code, etc.) to tag and store all messages that are requested by the users or transmitted back to the users.

In some instances, the stateful server includes advertisements in the messages transmitted to the users. The stateful server may utilize techniques as understood by people of ordinary skill in the art to transmit relevant advertisements (based on information in the message, e.g., advertisements to a concert of a similar genre when the user sends queries about local concerts in the genre). The advertisements may be included as part of the text messages sent to the user (e.g., an additional option that the user can select to receive more information about the advertised matter, etc.). In some instances, the stateful server may also send advertisements as stand-alone text messages.

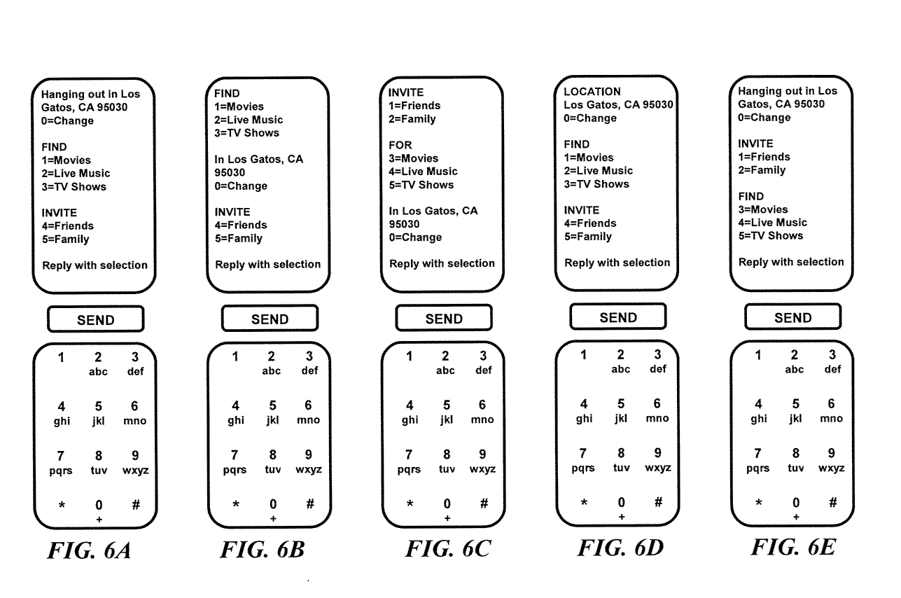

FIGS. 6A-6E depict various examples of the first list of options displayed in the user's mobile device. It is noted that these examples are for illustration only, and that other combinations of options and user interfaces can be used to display a list of options to the mobile user.

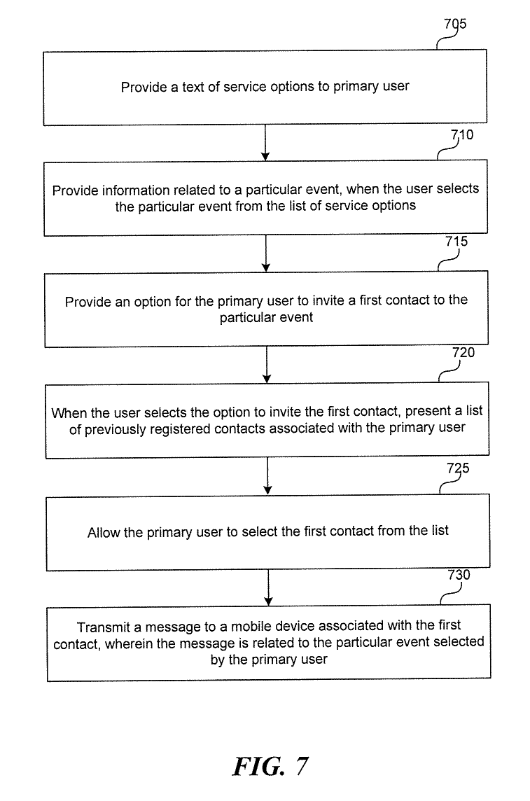

FIG. 7 is a flow diagram illustrating a method allowing a user to invite a contact from the user's friend network to a social event. As indicated above, the friend network service running on the stateful server transmits a first list of options to the user 705. At the same time, as indicated above, the stateful server also establishes a unique state using, for example, the user's registration code as an identifier to the unique state. When the user requests details for a particular event, the friend network service transmits additional details regarding the event, as previously discussed herein 710. In one embodiment, the message transmitted by the friend network service to the user includes an option allowing the user to invite one or more of his contacts to the event 715.

When the user selects such an option, in some instances, the friend network service provides the user with a list of contacts from the friend network that the user belongs to 720. The user may then select one or more contacts from the list and request the friend network service to forward information about the event to those users 725. The friend network service utilizes the information stored in association with the unique state to forward the message to the user. In some instances, the user can blast off the invite to all contacts in the friend network by sending a single message to the friend network service, which in turn transmits the message to the mobile device of each contact within the friend network 730. Additionally, in some instances, a particular contact may also “reply all” to a message received from another contact or from the primary user. In such instances, the response transmitted as a text message by the particular contact is transmitted to all other contacts (and the primary user) of the friend network. In other instances, the particular contact may also extend the “reply all” feature by engaging in a “group chat” with other contacts in the friend network by transmitting back and forth a series of messages.

In one embodiment, only the primary mobile user is allowed to send or forward messages to other contacts within a friend network. In other embodiments, any user (e.g., the primary user, the social contacts, etc.) is permitted to forward messages or invite other contacts. Additionally, in some instances the primary mobile user may place limits on the access levels or permission levels of other social contacts. In some instances, each user can place hooks on messages received or transmitted by the friend network service. For example, a user can place a hook indicating that he would like to receive messages only from the primary mobile user, or that he would like to only receive messages only about movies and not about music shows, etc. In some instances, for example, the user may also place hooks on the number of messages received using the friend network service, or the timing of the messages received from the service (e.g., the user may indicate that no messages be received after 10 PM every night).

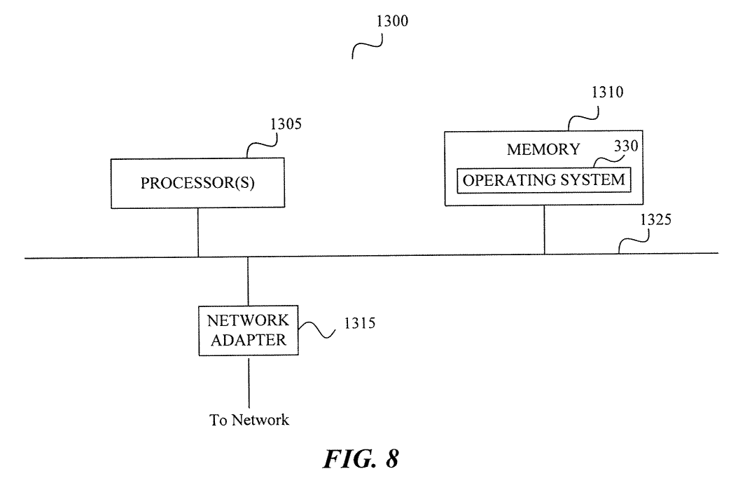

FIG. 8 is a high-level block diagram showing an example of the architecture for a computer system 1300 that can be utilized to implement a mobile device (e.g., 105 from FIG. 1), a stateful server (e.g., 125 from FIG. 1), etc. In FIG. 8, the computer system 1300 includes one or more processors 1305 and memory 1310 connected via an interconnect 1325. The interconnect 1325 is an abstraction that represents any one or more separate physical buses, point to point connections, or both connected by appropriate bridges, adapters, or controllers. The interconnect 1325, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, sometimes referred to as “Firewire”.

The processor(s) 1305 may include central processing units (CPUs) to control the overall operation of, for example, the host computer. In certain embodiments, the processor(s) 1305 accomplish this by executing software or firmware stored in memory 1310. The processor(s) 1305 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 1310 is or includes the main memory of the computer system 1100. The memory 1310 represents any form of random access memory (RAM), read-only memory (ROM), flash memory (as discussed above), or the like, or a combination of such devices. In use, the memory 1310 may contain, among other things, a set of machine instructions which, when executed by processor 1305, causes the processor 1305 to perform operations to implement embodiments of the present invention.

Also connected to the processor(s) 1305 through the interconnect 1325 is a network adapter 1315. The network adapter 1315 provides the computer system 1300 with the ability to communicate with remote devices, such as the storage clients, and/or other storage servers, and may be, for example, an Ethernet adapter or Fiber Channel adapter.

The algorithms and software presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from other portions of this description. In addition, the present invention is not described with reference to any particular programming language, and various embodiments may thus be implemented using a variety of programming languages.

The systems corresponding to the methods explained above and associated embodiments relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMS, and magnetic-optical disks, read-only memories (ROMs), random access memories (RAMs), EPROMs, EEPROMs, magnetic or optical cards, or any type of media suitable for storing electronic instructions, each coupled to a computer system.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

We claim:

1. A computer implemented method to enable a user to utilize a mobile device for social networking, the computer implemented method comprising:
transmitting, by a stateful server, a first tier of options to the user, wherein the first tier of options is received as a text message in a mobile device associated with the user;
receiving, by the stateful server, an input from the user based on the user's selection of an option from the text message displaying the first tier of options;
establishing a unique state in the stateful server in response to the user's input, wherein the stateful server fetches data corresponding to the user's response and stores the data in association with the unique state;
transmitting, by the stateful server, a reply message to the user's mobile device, wherein the stateful server utilizes the data stored in association with the unique state to generate the reply message; and
removing, by the stateful server, hyperlinks from the reply message prior to transmitting the reply message to the user's mobile device, wherein the stateful server stores, in association with the unique state, a correlation of the hyperlinks removed from the reply message to the corresponding data stored by the stateful server.

2. A computer implemented method to enable a user to use a mobile device for social networking as recited in claim 1, wherein the first tier of options includes a first option relevant to a geographic location associated with the user.

3. A computer implemented method to enable a user to use a mobile device for social networking as recited in claim 2, the method further comprising:
collecting a zip code associated with the user to enable the stateful server to provide the first option in association with the geographic location related to the zip code.

4. A computer implemented method to enable a user to use a mobile device for social networking as recited in claim 1, the method further comprising:
establishing a friend network for the user and storing the friend network in association with the unique state.

5. A computer implemented method to enable a user to use a mobile device for social networking as recited in claim 4, wherein the stateful server enables the user to include a first contact within the friend network.

6. A computer implemented method to enable a user to use a mobile device for social networking as recited in claim 5, wherein the stateful server enables the user to transmit a first message related to the data stored in association with the unique state to the first contact.

7. A computer implemented method to enable a user to use a mobile device for social networking as recited in claim 6, wherein the stateful server enables the first contact to transmit a first response to the first message, further wherein the first response is stored in association with the unique state.

8. A computer implemented method to enable a user to use a mobile device for social networking as recited in claim 7, wherein the stateful server enables the first contact to include a plurality of contacts from the friend network as recipients of the first response.

9. A computer implemented method to enable a user to use a mobile device for social networking as recited in claim 8, wherein the stateful server enables a second contact from the friend network to transmit a second response subsequent to receiving the first response, further wherein the second response is subsequently transmitted to the plurality of contacts.

10. A computer implemented method to enable a user to use a mobile device for social networking as recited in claim 1, wherein the reply message is a second tier of options.

11. A computer implemented method to enable a user to use a mobile device for social networking as recited in claim 10, wherein the stateful server stores the user's response to the second tier of options along with the data stored in association with the unique state.

12. A computer implemented method to enable a user to use a mobile device for social networking as recited in claim 11, wherein the stateful server generates a second reply message based on the data stored in association with the unique state.

13. A computer implemented method to enable a user to use a mobile device for social networking, the computer implemented method comprising:
using a stateful server to register a primary user in response to the primary user transmitting a registration code as a first text message, using the mobile device, to a number associated with the stateful server;
transmitting to the primary user a list of service options, wherein the list of service options is transmitted as a second text message to the mobile device;
receiving, as a third text message, a selection made by the user from the list of service options, wherein the received selection is stored in the stateful server in association with a state identified by the user's registration code;
generating a first response based on the user's selection and storing the first response in association with the state; and
transmitting the first response to the primary user's mobile device as a fourth text message, wherein the stateful server obfuscates hyperlinks within the first response before transmitting the text message, and wherein the stateful server stores, in association with the state, a corresponding correlation of the transmitted text message to the obfuscated hyperlinks.

14. A computer implemented method to enable a user to use a mobile device for social networking as recited in claim 13, the method further comprising:
authenticating the registration code prior to registering the primary user.

15. A computer implemented method to enable a user to use a mobile device for social networking as recited in claim 13, the method further comprising:
performing pre-management operations before registering the primary user.

16. A computer implemented method to enable a user to use a mobile device for social networking as recited in claim 13, wherein the list of service options includes a first option relevant to a geographic location associated with the primary user.

17. A computer implemented method to enable a user to use a mobile device for social networking as recited in claim 16, the method further comprising:
collecting a zip code associated with the primary user to enable the stateful server to provide the first option in association with the geographic location related to the zip code.

18. A computer implemented method to enable a user to use a mobile device for social networking as recited in claim 17, the method further comprising:
verifying the zip code provided by the primary user, wherein, when the zip code is found to be invalid, the stateful server transmits a new message to the primary user to collect a new zip code.

19. A computer implemented method to enable a user to use a mobile device for social networking as recited in claim 13, wherein, a given text message is sent as an SMS message.

20. A computer implemented method to enable a user to use a mobile device for social networking as recited in claim 13, wherein the primary user selects a single option from the list of service options, and wherein the stateful server generates the first response based on the single option.

21. A computer implemented method to enable a user to use a mobile device for social networking as recited in claim 13, wherein the primary user selects a range of options from the list of service options, and wherein the stateful server generates the first response based on each option indicated by the range of options.

22. A computer implemented method to enable a user to use a mobile device for social networking as recited in claim 13, wherein each option within the list of service options is assigned a specific priority value.

23. A computer implemented method to enable a user to use a mobile device for social networking as recited in claim 22, wherein a given message desired to be transmitted by the primary user to the stateful server is processed based on the priority value associated with the message.

24. A computer implemented method to enable a user to use a mobile device for social networking as recited in claim 22, wherein the stateful server, upon receiving a given message from the primary user, generates the first response to the given message based on the priority value associated with the message.

25. A computer implemented method to enable a user to use a mobile device for social networking as recited in claim 13, wherein the stateful server queries a network to generate the first response.

26. A computer implemented method to enable a user to use a mobile device for social networking as recited in claim 13, the method further comprising:
establishing a friend network for the primary user and storing the friend network in association with the state.

27. A computer implemented method to enable a user to use a mobile device for social networking as recited in claim 26, the method further comprising:
generating an authorization code in response to the primary user's request to add a new contact to the friend network and transmitting the authorization code as a fifth text message to the primary user's mobile device.

28. A computer implemented method to enable a user to use a mobile device for social networking as recited in claim 27, the method further comprising:
receiving the authorization code as a sixth text message from the new contact's mobile device, wherein the new contact receives the authorization code from the primary user;
authenticating the authorization code; and
registering the new contact as a first social contact within the friend network subsequent to the authentication.

29. A computer implemented method to enable a user to use a mobile device for social networking as recited in claim 28, the method further comprising:
receiving a request from the primary user, as a seventh text message from the primary user's mobile device, to transmit the first response stored in association with the state to the first social contact;
generating a forward message based on the first response stored in association with the state; and
transmitting, as an eighth text message, the forward message to the first social contact's mobile device.

30. A computer implemented method to enable a user to use a mobile device for social networking as recited in claim 29, wherein, the stateful server enables the first social contact to transmit the forward message to a second social contact's mobile device, wherein the second social contact is within the primary user's friend network.

31. A computer implemented method to enable a user to use a mobile device for social networking as recited in claim 28, wherein the stateful server enables the first social contact to request a new registration code to add a second social contact to the primary user's friend network.

32. A computer implemented method to enable a user to use a mobile device for social networking as recited in claim 28, wherein, upon request, the stateful server enables the first social contact to access the list of service options.

33. A computer implemented method to enable a user to use a mobile device for social networking as recited in claim 29, wherein the primary user places restrictions on the first social contact's ability to transmit the forward message.

34. A computer implemented method to enable a user to use a mobile device for social networking as recited in claim 29, wherein the stateful server enables the primary user or the first social contact to assign a control hook to control the receipt of a plurality of forward messages.

35. A computer implemented method to enable a user to use a mobile device for social networking as recited in claim 34, wherein the control hook includes assigning a limit on a number of forward messages received from the stateful sever during a given time period.

36. A stateful server to enable a user to use a mobile device for social networking, the stateful server comprising:
a processor;
a memory configured to store a set of instructions, which when executed by the processor cause the stateful server to perform a method, the method including:
registering a primary user in response to the primary user transmitting a registration code as a first text message using the mobile device to a number associated with the stateful server;
transmitting to the primary user a list of service options, wherein the list of service options is received as a second text message within the mobile device;
receiving, as a third text message, a selection made by the user from the list of service options, wherein the received selection is stored in the stateful server as a state identified by the user's registration code;
generating a first response based on the user's selection and storing the first response in association with the state; and
transmitting the first response to the primary user's mobile device as a fourth text message, wherein the stateful server obfuscates hyperlinks within the first response before transmitting the text message, and wherein the stateful server stores a corresponding correlation of the transmitted text message to the obfuscated hyperlinks in association with the state.

37. A stateful server to enable a user to use a mobile device for social networking as recited in claim 36, wherein the stateful server is further configured to establish a friend network for the primary user.

38. A stateful server to enable a user to use a mobile device for social networking as recited in claim 37, wherein the stateful server is further configured to generate an authorization code in response to the primary user's request to add a contact to the friend network, and to transmit the authorization code as a fifth text message to the primary user's mobile device.

39. A stateful server to enable a user to use a mobile device for social networking as recited in claim 38, wherein the stateful server is further configured to:
receive the authorization code as a sixth text message from the contact's mobile device, wherein the contact receives the authorization code from the primary user;
authenticate the authorization code; and
register the contact as a first social contact within the friend network subsequent to the authentication.

40. A stateful server to enable a user to use a mobile device for social networking as recited in claim 39, wherein the stateful server is further configured to:
receive a request from the user, as a seventh text message from the primary user's mobile device, to transmit the first response stored in association with the state to the first social contact;
generate a forward message based on the first response stored in association with the state; and
transmit, as an eighth text message, the forward message to the first social contact's mobile device.

41. A stateful server to enable a user to use a mobile device for social networking as recited in claim 40, wherein, the stateful server enables the first social contact to transmit the forward message to a second social contact's mobile device, wherein the second social contact is within the primary user's friend network.

42. A stateful server to enable a user to use a mobile device for social networking as recited in claim 40, wherein the stateful server enables the first social contact to request a new registration code to add a second social contact to the primary user's friend network.

43. A stateful server to enable a user to use a mobile device for social networking as recited in claim 40, wherein, upon request, the stateful server enables the first social contact to access the list of service options.

44. A stateful server to enable a user to use a mobile device for social networking as recited in claim 40, wherein the stateful server enables the primary user to place restrictions on the first social contact's ability to transmit the forward message.

45. A stateful server to enable a user to use a mobile device for social networking as recited in claim 40, wherein the stateful server enables the first social contact to transmit a first response to the forward message, further wherein the first response is stored in association with the state.

46. A stateful server to enable a user to use a mobile device for social networking as recited in claim 45, wherein the stateful server enables the first social contact to include a plurality of contacts from the friend network as recipients of the first response.

47. A stateful server to enable a user to use a mobile device for social networking as recited in claim 46 wherein the stateful server enables a second social contact from the friend network to transmit a second response subsequent to receiving the first response, further wherein the second response is subsequently transmitted to the plurality of contacts.
